(19) United States
(12) Patent Application Publication
(10) Pub. No.: US 2024/0399430 A1
(43) Pub. Date: Dec. 5, 2024

(54) RECYCLING OF BATTERIES WITH A VACUUM CRUSHING-VAPORIZATION-COLLECTION SYSTEM

(71) Applicant: Evolve Renewable Materials, Inc., Oak Ridge, TN (US)

(72) Inventors: Frank Ding, Waxhaw, NC (US); Wesley D. Tennyson, Oak Ridge, TN (US); Michael Z. Hu, Knoxville, TN (US); Stephanie A. Spittle, Knoxville, TN (US); Zackary Emery, Knoxville, TN (US)

(21) Appl. No.: 18/405,952

(22) Filed: Jan. 5, 2024

Related U.S. Application Data
(63) Continuation of application No. PCT/US2024/010549, filed on Jan. 5, 2024.
(60) Provisional application No. 63/615,186, filed on Dec. 27, 2023.
(60) Provisional application No. 63/478,915, filed on Jan. 6, 2023.

(51) Int. Cl. B09B 3/35; B09B 3/40; B09B 3/80; B09B 101/16

(52) U.S. Cl. CPC B09B 3/35; B09B 3/40; B09B 3/80; B09B 2101/16

(57) ABSTRACT

According to an aspect, the present disclosure provides a method of recycling batteries. The method may comprise loading a battery into a processing system before pre-conditioning the battery and processing system, then shredding the battery under a vacuum condition and recovering a solvent chemical.

### CROSS-REFERENCE

This application is a continuation of International Patent Application No. PCT/US2024/010549 filed on Jan. 5, 2024 which claims priority to U.S. Provisional Patent Application No. 63/478,915 filed Jan. 6, 2023, and U.S. Provisional Patent Application No. 63/615,186, filed Dec. 27, 2023, each of which is entirely incorporated herein by reference.

### BACKGROUND

The supply of End-of-Life (EoL) lithium batteries has been increasing exponentially in recent years and will continue to rise with the increasing popularity of electric vehicles and rechargeable electronics. Currently, the supply of battery materials (e.g., Co, Ni, Mn, and Li) lags significantly behind its demand. Even if mining may be scaled in sync with growing demand, the development of those mining resources does not address the on-going need to develop sustainable methods to reuse these rare and critical materials. Recycling lithium-containing batteries in a way that minimizes impact to the environment, while maintaining high product quality, and managing all the hazards present are major challenges for the battery recycling industry.

One of these hazards is the potential for flair events (lithium fire) when the battery is being crushed or shredded. Lithium batteries contain a large amount of electrolyte solvent chemicals which are volatile and very flammable. These liquid chemicals will inevitably leak out when the battery is shredded. Additionally, batteries are not usually 100% discharged, and strongly exothermal chemical reactions will take place when the anode materials, containing some residual lithium atoms, are in contact with the cathode materials. These exothermal reactions will cause violent temperature increases and, in some areas, the production of sparks. This may ignite the electrolyte solvent chemicals if sufficient oxygen is present in the environment.

Electrolyte solvent chemicals may vary based on the different types of lithium batteries. Commonly used solvent chemicals include ethylene carbonate (EC, boiling point 244° C.), propylene carbonate (PC, boiling point 241° C.), dimethyl carbonate (DMC, boiling point 91° C.), diethyl carbonate (DEC, boiling point 127° C.), ethyl methyl carbonate (EMC, boiling point 110° C.) and some mixtures of these chemicals. To effectively remove the solvent chemicals from the crushed battery solids, a high heating temperature can be applied. However, this elevated temperature may result in unwanted decomposition of the solvent chemicals, emitting toxic or reactive pollutants to the atmosphere, causing significant environmental impacts.

In some applications, inert gas is used to fill the chamber of the shredder and expel oxygen from the atmosphere. It is much less likely that the solvent chemicals can be ignited when there is a deficiency of oxygen. This method, albeit effective in suppressing the fire hazard, increases the operation cost by using significant amounts of inert gases, such as nitrogen. In addition, solvent chemicals are not effectively recovered. These solvent chemicals are typically burned in successive processes, which increase unwanted pollution and carbon emission to the atmosphere. A multi-chamber shredder design in combination with nitrogen gas purging was recently reported to suitably crush the batteries that contain electrolyte liquid (Zhang et al., 2022). In some other applications, vacuum (i.e., ambient negative pressure) is used for the battery dismantling and crushing steps (Lai et al., 2019). Hot dry air flow was blown to the large surface areas of crushed solid pieces in the vacuumed space to effectively evaporate the electrolyte liquid; and the volatile component was then condensed, filtered, and de-fluorinated by alkali to recover relatively pure, harmless organic/electrolyte solvent.

In some other crushing applications, liquid such as water, is added to reduce the fire hazard. However, the liquid will have to be removed from the wet comminuted materials in successive processes, which inevitably increases operation cost. Again, solvent chemicals cannot be effectively recovered as these chemicals are not readily soluble to the liquid (water). Moreover, electrolyte chemical (conducting salt), such as Lithium Hexafluorophosphate (LiPF6), will react with water and emit hydrogen fluoride (HF), which is extremely toxic and corrosive:

LiPF₆+5H₂O→6HF+H₃PO₄+LiOH

### SUMMARY

The present disclosure relates to a batch and continuous processing method to shred batteries (e.g., lithium batteries) and vaporize-recover volatile organic materials under vacuum. In some examples, a battery recycling system is constructed with crushing equipment, including a shredder, which is sealed to maintain a vacuum environment. Lithium batteries may be fed into the crushing system via a feeder chamber, preconditioned by cleaning, drying, purging, and vacuuming. The batteries may then be transferred into a crushing chamber and shredded into small pieces under a designated vacuum. The vacuum environment may prevent any fire hazards from the reactions of the battery materials with oxygen. The shredded material may be subsequently heated to a designated temperature just above the boiling point(s) of the solvent chemical(s) used in the batteries, at the given pressure in the vacuum. Because the boiling points under the vacuum are much lower than those in ambient pressure, the temperature for effective evaporation of solvents from crushed solids can be kept significantly lower relative to a system operating under ambient conditions. The low temperature may prevent or minimize unwanted chemical decomposition reactions, hence reducing the emission of toxic gases during the process. Inert gas may be passed through the shredded materials to help purge out the solvent vapors. The solvent vapors may be pulled out from the crushing/vaporizing chamber and condensed into liquid in a condensation-recovery unit. A dust filtration unit may also be used to collect any particulate particles emitted from the crushing-vaporizing processes. In some embodiments, a semi-continuous crushing-vaporizing system can be constructed by adding a pre-conditioning feeder chamber before the crushing equipment, post-conditioning chamber(s) after the crushing, a liquid storage vat for catching excess liquid droplets, and a distillation unit attached to the liquid storage vat. The pre-conditioning feeder chamber may be operated in batch mode, where the batteries are sealed, pre-condoned and vacuumed, and then dropped into the crushing chamber. Post-conditioning chamber(s) may contain a temperature regulated conveyance unit, such as screen conveyer, shaker table, screw conveyor, etc. The comminuted material may be dropped onto the conveyance unit, heated to a designated temperature under vacuum such that the solvent chemicals are evaporated, purged by gas flow, and recovered by the condenser unit. In some embodiments, the comminuted materials are sprayed with a working liquid to rinse off any residual electrolyte, further reducing fire hazards and risk of HF production in later processing steps. The excess working liquid and solvent chemicals that do not get vaporized may fall into a storage vat. Finally, the dry, solvent-free shredded material may be sorted by the separator into fine black mass and coarse solids, which are dropped into individual product chambers and discharged in batch operations. This may improve the battery recycling process by at least the following factors: (i) reducing/preventing the fire hazard; (ii) safely vaporizing and/or recovering the solvent chemicals while minimizing unwanted chemical decomposition; (iii) eliminating fine particulate hazards while the batteries are crushed and processed.

According to one aspect, the present disclosure provides a method of recycling batteries. The method may comprise of loading a battery into a processing system before pre-conditioning the battery and processing system, then shredding the battery under a vacuum condition and recovering solvent chemicals and electrolytes (electrolyte mix). According to some aspects, recovering the solvent chemical may comprise of evaporating the solvent chemicals and/or collecting excess liquid in a storage vat. The solvent chemical may be heated to evaporate the solvent chemical. In some embodiments, the solvent chemical may be heated to a range between 40˜60° C. In some embodiments, the solvent chemical may be heated to a point below the chemical decomposition temperature.

The vaporized solvent chemicals may then be condensed into a liquid after it has been evaporated, according to some embodiments. The solvent chemical may be condensed into a liquid by pulling the solvent chemical into a condenser after the solvent chemical is evaporated. In some embodiments, the condenser includes a cooling element. In some embodiments, there is a second condenser after an additional pump to condense the vapor that was missed by the first condenser chamber. The second condenser may be at a higher pressure/colder temperature than the first condenser. In some embodiments, a pressure swing adsorber is utilized after the first condenser to capture and concentrate the vapor stream while providing a clean inert gas stream back into the system.

According to some embodiments, preconditioning the battery and processing system includes placing an internal volume of the processing system under vacuum conditions. In some embodiments, the processing system may be purged with a controlled stream of inert gas while approaching vacuum conditions. Purging with inert gas while approaching vacuum conditions may further reduce oxygen content in the processing system. Inert gas may also be provided to the processing system to carry the evaporated solvent chemical to the condenser. In some embodiments, the vacuum condition may be about 0.05 atm. Pre-conditioning the battery may comprise of cleaning, purging, and drying the battery in some embodiments. The processing system may be controlled by an electronic control unit in some embodiments.

In some embodiments, the comminuted materials may be washed with a working liquid. The working liquid may consist of recycled solvent chemicals or other organic solvents. Electrolyte mix that was not vaporized quickly enough may drop down into a storage vat from the conveyance unit. In some embodiments, the electrolyte mix may be transferred to a distillation unit. In some embodiments, electrolyte salts are separated from solvents in the distillation unit. In other embodiments, the distillation unit may be used to separate the solvents from one another.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

Lei Zhang, Jiecong Li, Weiwen He, and Weiwen Yang, “− [symbol] [symbol] [symbol] [symbol] [symbol] [symbol] [symbol] [symbol] [symbol] [symbol] (A kind of shredder for electrolyte liquid-containing batteries),” CN 216597713 U, May 24, 2022.

Yanqing Lai, Zhian Zhang, Xiaolin Yan, Jing Fang, Bo Hong, Kai Zhang, and Ji Li, “− [symbol] [symbol] [symbol] [symbol] [symbol] [symbol] [symbol] [symbol] [symbol] [symbol] [symbol] [symbol] [symbol] [symbol] [symbol] [symbol] (A kind of waste and old lithium ionic cell electrolyte recovery method),” CN 106684487 B, Jul. 2, 2019.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows a graph depicting a relationship of a boiling point vs pressure for four commonly used electrolyte solvents;

FIG. 2 shows a diagram of a primary exemplary batch operation processing system for processing batteries in batches and collecting and recycling solvent chemicals, according to one or more embodiments herein;

FIG. 3 shows a diagram of a primary exemplary method of processing batteries and collecting and recycling solvent chemicals, according to one or more embodiments herein;

FIG. 4 shows a diagram of a primary exemplary semi-continuous operation processing system for processing batteries and collecting and recycling solvent chemicals, according to one or more embodiments herein;

FIG. 5 shows a diagram of a secondary exemplary semi-continuous operation processing system for processing batteries and collecting and recycling solvent chemicals, according to one or more embodiments herein;

FIG. 6 shows a diagram of a primary first solvent recovery unit 400A for collecting and recycling solvent chemicals, according to one or more embodiments herein, according to one or more embodiments herein;

FIG. 7 shows a diagram of a primary second solvent recovery unit 400B for collecting and recycling solvent chemicals, according to some embodiments, according to one or more embodiments herein;

FIG. 8 shows a diagram of a secondary batch operation processing system for processing batteries in batches and collecting and recycling solvent chemicals, according to one or more embodiments herein;

FIG. 9 shows a diagram of a secondary method of processing batteries and collecting and recycling solvent chemicals, according to one or more embodiments herein;

FIG. 10 shows a diagram of a tertiary semi-continuous operation processing system for processing batteries and collecting and recycling solvent chemicals with a conveyance unit, according to one or more embodiments herein;

FIG. 11 shows a diagram of a quaternary semi-continuous operation processing system for processing batteries and collecting and recycling solvent chemicals with a shaker table, according to one or more embodiments herein;

FIG. 12 shows a diagram of a secondary second solvent recovery unit 400C, according to some embodiments, according to one or more embodiments herein;

FIG. 13 shows a diagram of a secondary second solvent recovery unit with cyclic solvent absorbent beds, according to some embodiments, according to one or more embodiments herein; and

FIG. 14 shows a computer control system that is programmed or otherwise configured to implement methods provided herein, according to one or more embodiments herein.

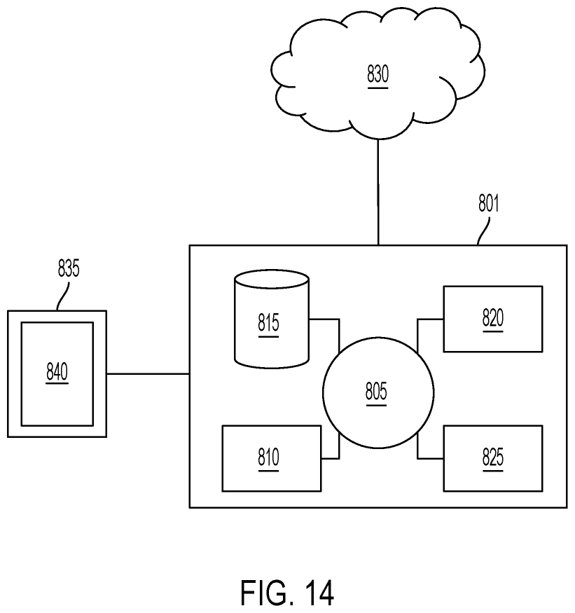

FIG. 15 shows a diagram of a quinary semi-continuous operation processing system for processing batteries and collecting and recycling solvent chemicals with a screw conveyor, according to one or more embodiments herein;

### DETAILED DESCRIPTION

The present disclosure reduces issues of conventional methods of solvent recovery and battery recycling. In particular, the risk of a fire hazard is reduced, and solvent chemicals may be safely vaporized and recovered with minimal unwanted chemical decomposition, and the risk of fine particulate hazards as batteries are crushed and processed is reduced as well.

Many of the benefits of the present disclosure result from the Antoine equation:

$${P}_{v} = A - \frac{B}{T + C}$$

where Pᵥ=vapor pressure, T is temperature, and A, B, and C are model parameters.

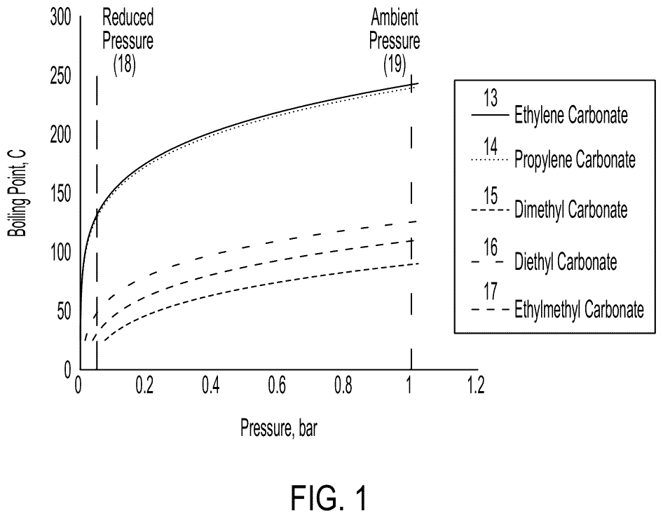

FIG. 1 illustrates a graph of the relationship of the boiling point (in ° C., Celsius) vs pressure (in atm) for four commonly used electrolyte solvents: ethylene carbonate (EC) 13, propylene carbonate (PC) 14, dimethyl carbonate (DMC) 15, diethyl carbonate (DEC) 16, and ethyl methyl carbonate (EMC). As shown at 18, with ambient atmospheric pressure of around 1 atm, it is required to heat the solvents over 250° C. in to effectively evaporate all the solvent chemicals. This elevated temperature may cause or accelerate some unwanted chemical decomposition, especially the decomposition of an electrolyte, particularly when moisture is present. By reducing the pressure, the temperature required to vaporize all solvent chemicals from the crushed battery solids may be reduced. For example, at 18, at a pressure of about 0.05 atm, the minimum boiling temperature to evaporate all four solvents (13, 14, 15, 16) may be reduced 19 to a temperature below 150° C. Therefore, effective evaporation of all four solvents (13, 14, 15, 16) may be expected if we heat the comminuted material to a relatively lower temperature, where unwanted decomposition of a solvent is less likely also.

Additionally, oxygen concentration may be reduced in a reduced pressure environment. For example, at a pressure of 0.05 atm, oxygen concentration may be reduced to below 5% of the oxygen concentration at 1 atm, which may be equivalent to 1% or less of total oxygen content at normal atmospheric pressure. Reducing the oxygen concentration may suppress oxidation reactions, i.e., fire or explosion. According to some embodiments, a stream of inert gas may be purged through the crushing chamber, which may further reduce the oxygen content in the crushing chamber.

At a reduced pressure, contaminants such as particulate dust, volatile organic vapors, toxic or reactive gases, may also be more effectively confined in a negative pressure closed system and may be properly processed and neutralized with little chance of being leaked to the environment.

### Primary Batch Operation Processing System

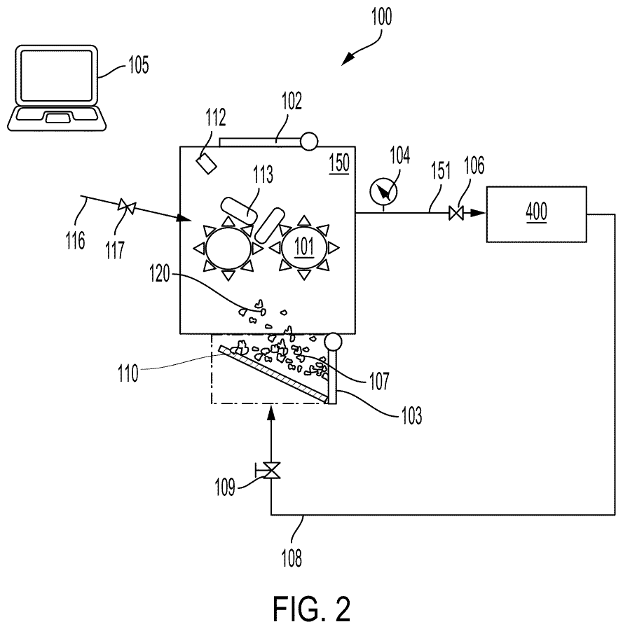

FIG. 2 shows a primary batch operation processing system 100 for processing batteries 113 in batches and collecting and recycling solvent chemicals, according to some embodiments. The system comprises a crusher (e.g., a shredder) 101. The crusher 101 is sealed in an air-tight crushing chamber 150 having an entry door 102 and an outlet door 103. The air-tight crushing chamber 150 comprises a chamber valve 117 in fluid connection between the air-tight crushing chamber 150 and cold compressed inert gas 116. A conduit pipe 151 has a first end in fluid communication to the air-tight crushing chamber 150 and a second end in fluid communication to a solvent recovery unit 400. The conduit pipe 151 comprises a conduit valve between the air-tight crushing chamber 150 and a solvent recovery unit 400. The solvent recovery unit 400 comprises a vacuum compressor, which pulls the pressure of the air-tight crushing chamber 150 down to a desired value. A pressure sensor 104 may be connected in fluid communication to the air-tight crushing chamber 150 or the conduit pipe 151. The pressure sensor 104 monitors a pressure of the air-tight crushing chamber 150. In some embodiments, the pressure sensor 104 sends a signal to an Electronic Controlling Unit (ECU) 105.

The system also comprises a separation unit 110, which forms an airtight connection to the air-tight crushing chamber 150. The separation unit 110 separates a quantity of black mass and other fine particles from a quantity of crushed chips after the crushed chips move through the crusher 101. In some embodiments, the separation unit 110 is a vibration sieve. In some embodiments, the separation unit 110 is a shaker table. According to another embodiment, the separation unit 110 is a combination of a sieve and a shaker table. In some embodiments, the black mass consists of fine particles. In some embodiments, the black mass is dropped onto a heating unit 111. A temperature of the separation unit 110 may be regulated to a desired value. In some embodiments, the temperature of the separation unit 110 is controlled by the ECU 105. For example, in some embodiments, the temperature of the separation unit 110 is regulated to 200° C. Temperature sensors (not shown in the figure) measures the temperature of the separation unit 110. In an embodiment, the ECU 105 receives a feedback control logic to regulate the temperatures to the desired level.

Batteries 113 are loaded into the crusher 101. According to some embodiments, a separation unit door 103 is opened and comminuted material 107 may also be released from the separation unit 110 through the separation unit door 103. The conduit valve 106 is shut off, as well as the chamber valve 117 and the separation unit valve 109 before the entry door 102 is opened to load batteries 113 into the crusher 101. According to some embodiments, the crusher 101 is also turned off before batteries 113 are loaded.

The batteries 113 are preconditioned. According to some embodiments, the batteries 113 are preconditioned by cleaning, purging, and drying the batteries. The air-tight crushing chamber 150 is also pulled to a desired vacuum pressure after the entry door 102 and the outlet door 103 are closed. In some embodiments, pulling the air-tight crushing chamber 150 to a desired vacuum condition involves opening the conduit valve 106 and the separation unit valve 109. In some embodiments, a dry inert gas 108 is passed through the system. Dry inert gas 116 may also be passed through the system if chamber valve 117 is opened. In some embodiments, the dry inert gas 108 is passed through the system to purge and dry the batteries 113 until the batteries 113 are dry and the pressure in the air-tight chamber is pulled down to a desired value. In some embodiments, the separation unit valve 109 is controlled by the ECU 105 such that the vacuum inside the system is kept at a constant level, e.g., 0.05 atm.

The batteries 113 are crushed and/or shredded under regulated temperature and vacuum conditions by the crusher 101 in the airtight chamber 150. During this step, the temperature of the separation unit 110 may be regulated to a designated value and/or the pressure may be regulated to a designated value in some embodiments. For example, in some embodiments, the temperature of the separation unit 110 is regulated to 40° C. and the pressure in the airtight chamber is regulated to 0.05 atm. The crusher 101 is then turned on, which crushes/shreds the batteries 113 into comminuted material 107. The comminuted material is dropped on the separation unit 110, where the small particle black mass is partially separated from the large particle crushed chips. The black mass and the crushed chips are heated to a desired temperature. In some embodiments, the black mass and the crushed chips are heated to a temperature above the boiling points of some or all electrolyte solvents at the lowered pressure, resulting in the electrolyte solvents evaporating away from the crushed solids. The evaporated electrolyte solvents are then carried through the conduit pipe 151 to the solvent recovery unit 400. In some embodiments, a stream of inert gas may flow through the separation unit 110 and carry the solvent vapors to the solvent recovery unit 400, where the evaporated solvents are then condensed and recovered. In some embodiments, airborne contaminants comprising particulates and/or vapor, are also carried to the solvent recovery unit 400, where they are contained and recovered by filtration of particulates and/or condensation of vapor.

The remaining evaporated solvents are collected and condensed after all the batteries 113 are crushed/shredded. In some embodiments, the crusher 101 is stopped. In some embodiments, the inert gas 109 continues to carry evaporated solvent chemicals to the solvent recovery unit 400, until most of the solvent chemicals are evaporated/recovered, and/or the airborne contaminants/dusts are completely purged and removed. At this time, the system should be contaminant free and ready for the next batch of operation.

In some embodiments, the air-tight crushing chamber 150 comprises a temperature sensor 112. In some embodiments, the temperature sensor 112 may be an infrared camera, infrared temperature sensor, or other electronic temperature sensor. The temperature sensor 112 is installed inside the air-tight chamber to monitor the temperature of the batteries 113 being crushed and/or shredded. In some embodiments, a temperature signal is transmitted to the ECU 105 to monitor any potential fire hazard. In some embodiments, if the temperature in the crushing zone is higher than a maximum allowable value, e.g., the lowest chemical decomposition temperature, the ECU 105 opens the air-tight chamber valve 117, which allows a controlled stream of a cold, compressed inert gas 116 to jet onto the crushing zone, thus reducing the temperature at the crushing zone below a maximum allowable value.

### Secondary Batch Operation Processing System

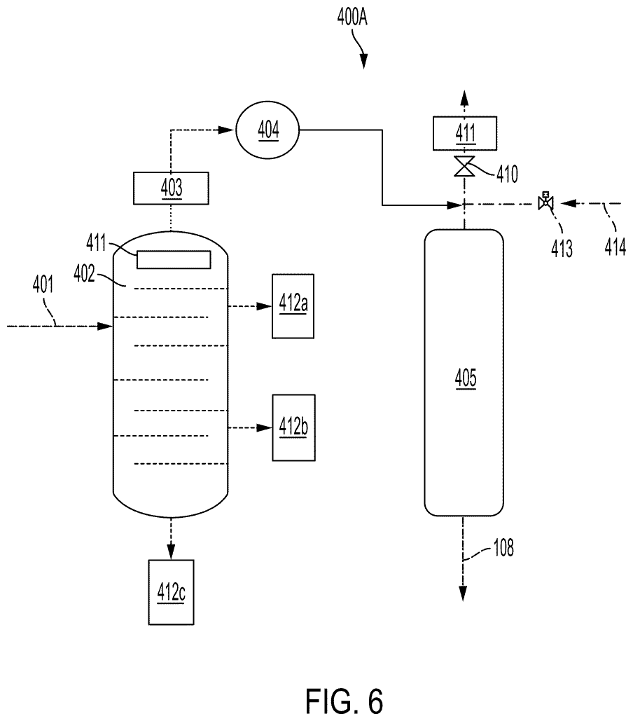

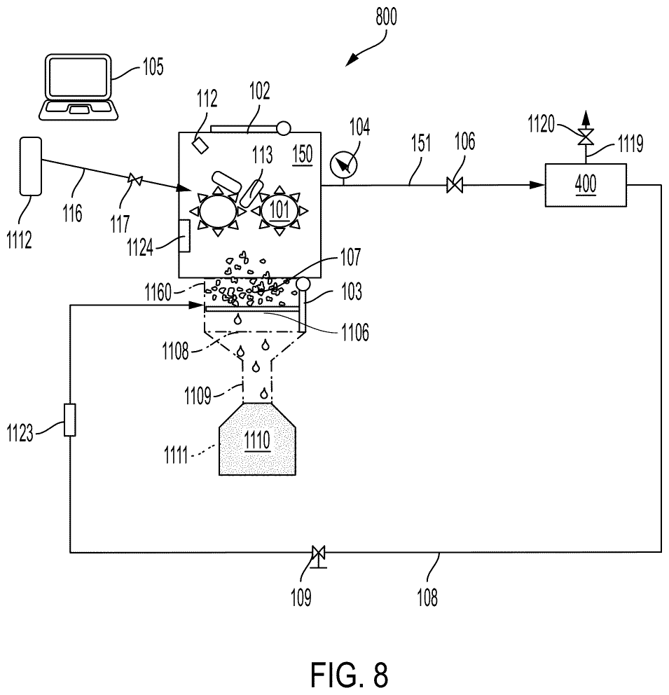

FIG. 8 shows a secondary batch operation processing system 800 for processing batteries 113 in batches and collecting and recycling electrolyte salts and/or solvent chemicals, according to some embodiments. The system comprises a crusher (e.g., a shredder) 101. The crusher 101 is sealed in an air-tight crushing chamber 150 having an entry door 102 and an outlet door 103. The air-tight crushing chamber 150 comprises a chamber valve 117 in fluid connection between the air-tight crushing chamber 150 and cold compressed inert gas 116 from an inert gas source 1112. A conduit pipe 151 transmits fluid from the air-tight crushing chamber 150 to a solvent recovery unit 400. The conduit pipe 151 comprises a conduit valve 204 between the air-tight crushing chamber 150 and a solvent recovery unit 400. In some embodiments, the solvent recovery unit 400 comprises a vacuum compressor, which pulls the pressure of the air-tight crushing chamber 150 down to a desired value when conduit valve 118 is opened. In some embodiments, a vacuum compressor 404 (FIGS. 6-7, 12) is a part of the solvent recovery unit 400, depicted in FIG. 8. In other embodiments, the vacuum compressor is pulled out before the solvent recovery unit 400 (not shown). In some embodiments, the solvent recovery unit 400 further comprises a vent line 1119 and a vent valve 1120 to exhaust gas in the solvent recovery unit 400.

A pressure sensor 104 may be connected in fluid communication to the air-tight crushing chamber 150 or the conduit pipe 151. The pressure sensor 104 monitors a pressure of the air-tight crushing chamber 150. In some embodiments, the pressure sensor 104 sends a signal to an Electronic Controlling Unit (ECU) 105.

The system also comprises a separation unit 1106, which forms an airtight connection to the air-tight crushing chamber 150. In some embodiments, the separation unit 1106 separates finer particles, such as black mass, from comminuted materials 107. In other embodiments, the separation unit 1106 is used to separate solid comminuted materials from electrolyte mix 1110. Depending on the filter size of the separation unit 1106, fine particles may still pass through, regardless of its intended purpose. To further separate the materials, in some embodiments, a fine filter 1108 may be placed below the separation unit 1106 to separate the fine black mass particles from the electrolyte mix 1110. In some embodiments, the electrolyte mix 1110 is directed by a funnel 1109 into a detachable storage vat 1111. In some embodiments, the separation unit 1106 comprises a vibration sieve. In some embodiments, the separation unit 1106 is a shaker table. According to another embodiment, the separation unit 1106 is a combination of a sieve and a shaker table.

In some embodiments, the black mass consists of fine particles. A temperature of the separation unit 1106 may be regulated to a desired value. In some embodiments, the temperature of the separation unit 1106 is controlled by the ECU 105. For example, in some embodiments, the temperature the separation unit 1106 is regulated to 200° C. Temperature sensors (not shown in the figure) measure the temperature of the separation unit 1106. In an embodiment, the ECU 105 receives a feedback control logic to regulate the temperatures to the desired level.

Batteries are loaded into the crusher 101. According to some embodiments, a separation unit door 103 is opened and comminuted material 107 may also be released from the separation unit 110 through the separation unit door 103. The conduit valve 106 is shut off, as well as the chamber valve 117 and the separation unit valve 109 before the entry door 102 is opened to load batteries into the crusher 101. According to some embodiments, the crusher 101 is also turned off before batteries are loaded.

Batteries 113 are loaded into the crushing chamber 150 through entry door 102. According to some embodiments, the batteries are preconditioned by cleaning, purging, and drying the batteries. The air-tight crushing chamber 150 is also pulled to a desired vacuum condition after the entry door 102 and the outlet door 103 are closed. In some embodiments, pulling the air-tight crushing chamber 150 to a desired vacuum condition involves opening the conduit valve 106 and turning on the vacuum compressor inside the solvent recovery unit 400. In some embodiments, a controlled stream of dry inert gas 108 can be passed through the system to purge and dry the batteries 113 until the batteries 113 are dry and the pressure in the air-tight chamber is pulled down to a desired value. In some embodiments, the separation unit valve 109 is controlled by the ECU 105 such that the vacuum inside the system is kept at a constant level (e.g., 0.05 atm). In some embodiments, a temperature of the dry inert gas 108 that passes through the separation unit valve 109 is regulated by a temperature regulator 1123.

The batteries 113 are crushed and/or shredded under regulated temperature and vacuum conditions by the crusher 101 in the airtight chamber 150. During this step, the temperature of the separation unit 1106 may be regulated to a designated value and/or the pressure may be regulated to a designated value in some embodiments. For example, in some embodiments, the temperature of the separation unit 1106 is regulated to 40° C. and the pressure in the airtight chamber is regulated to 0.05 atm. The crusher 101 is then turned on, which crushes/shreds the batteries 113 into comminuted material 107. The comminuted material 107 is dropped on the separation unit 1106, where the small particle black mass and/or electrolyte mix could be partially separated from the large particle crushed chips. In some embodiments, to recover the remaining electrolyte solvents that did not drip down into the storage vat 1111, the black mass and the crushed chips are heated to a desired temperature by a heater 1124. In some embodiments, the black mass and the crushed chips are heated to a temperature above the boiling points of some or all electrolyte solvents at the lowered pressure, resulting in the electrolyte solvents evaporating away from the crushed solids. The evaporated electrolyte solvents are then carried through the conduit pipe 151 to the solvent recovery unit 400. In some embodiments, a stream of inert gas may flow through the separation unit 1106 and carry the solvent vapors to the solvent recovery unit 400, where the evaporated solvents are then condensed and recovered. In some embodiments, airborne contaminants comprising particulates and/or vapor, are also carried to the solvent recovery unit 400, where they are contained and recovered by filtration of particulates and/or condensation of vapor.

The remaining evaporated solvents are collected and condensed after all the batteries 113 are crushed/shredded. In some embodiments, the crusher 101 is stopped. In some embodiments, the inert gas 116 continues to carry evaporated solvent chemicals to the solvent recovery unit 400, until most of the solvent chemicals are evaporated/recovered, and/or the airborne contaminants/dusts are completely purged and removed. At this time, the system should be contaminant free and ready for the next batch of operation.

The pressure may be brought back up to ambient conditions by shutting the conduit valve 106, and opening chamber valve 117 and/or separation unit valve 109 to flush the system with inert gas via gas lines 116 and/or 108. When the appropriate pressure is achieved, chamber valve 117 and/or separation unit valve 109 may be turned off. According to some embodiments, outlet door 103 can then be opened and comminuted material 107 may also be collected off the separation unit 1106. At this time, any finer particles may also be collected off the fine filter 1108. The outlet door 103 may be closed, and the system is ready to begin another batch operation. According to some embodiments, the crusher 101 is turned off before batteries are loaded. At this time, the detachable liquid storage vat 1111 may be removed so electrolyte mix 1110 can be collected as well.

In some embodiments, the air-tight crushing chamber 150 comprises a temperature sensor 112. In some embodiments, the temperature sensor 112 may be an infrared camera, infrared temperature sensor, or other electronic temperature sensor. The temperature sensor 112 is installed inside the air-tight chamber to monitor the temperature of the batteries 113 being crushed and/or shredded. In some embodiments, a temperature signal is transmitted to the ECU 105 to monitor any potential fire hazard. In some embodiments, if the temperature in the crushing zone is higher than a maximum allowable value, e.g., the lowest chemical decomposition temperature, the ECU 105 opens the air-tight chamber valve 117, which allows a controlled stream of a cold, compressed inert gas 116 to jet onto the crushing zone, thus reducing the temperature at the crushing zone below a maximum allowable value.

### Primary Semi-Continuous Operation Processing System

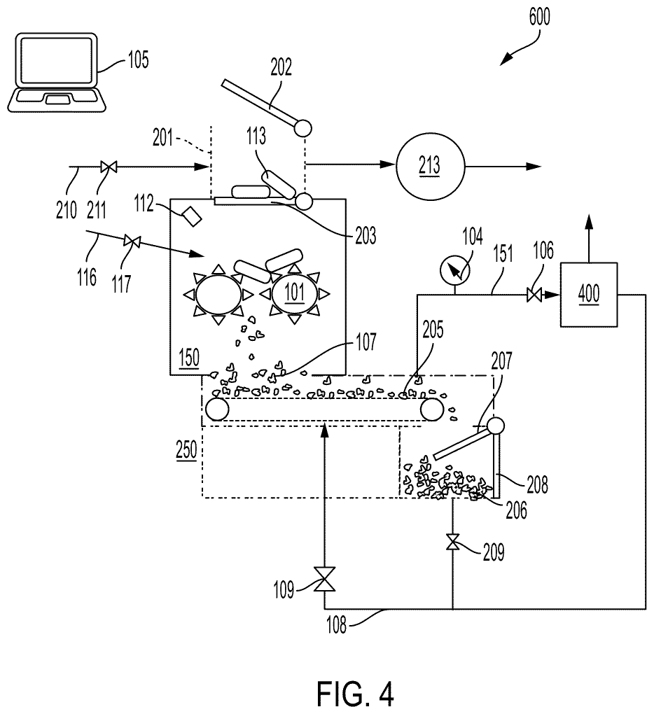

FIG. 4 shows a primary semi-continuous operation processing system 600 for processing batteries 113 and collecting and recycling solvent chemicals, according to some embodiments. According to some embodiments, the primary semi-continuous operation processing system 600 comprises a crusher 101 similar to that of the primary batch operation processing system 100. In some embodiments, the crusher 101 of the primary semi-continuous operation processing system 600 of FIG. 4 runs continuously. The primary semi-continuous operation processing system 600 may also comprise a batch-operated pre-conditioning chamber 201 according to some embodiments. In some embodiments, the pre-conditioning chamber 201 may comprise a pre-conditioning chamber inlet door 202 on a first side of the pre-conditioning chamber 201 and a pre-conditioning chamber outlet door 203 on a second side of the pre-conditioning chamber 201. The pre-conditioning chamber inlet door 202 enables the pre-conditioning chamber 201 to open to ambient air for loading batteries 113 into the pre-conditioning chamber 201. The pre-conditioning chamber 201 may be fixed to an air-tight crushing chamber 150 such that the pre-conditioning chamber outlet door 203 is shared between the pre-conditioning chamber 201 and the air-tight crushing chamber 150. The air-tight crushing chamber 150 comprises a crusher 101. The pre-conditioning chamber 201 may also be attached to a pre-conditioning chamber valve 211 having a first end in fluid communication with the internal volume of the pre-conditioning chamber 201 and a second end in fluid communication with a source of dry air 210. The internal volume of the pre-conditioning chamber 201 may also be in fluid communication with a vacuum compressor 213. In some embodiments, the vacuum compressor 213 is on an opposite side of the pre-conditioning chamber 201 across from the pre-conditioning chamber valve 211.

The crushing chamber 150 may be pre-conditioned by purging with inert gas 116 when chamber valve 117 is opened. The vacuum compressor in the solvent recovery unit 400 is turned on to pull the pressure of the air-tight crushing chamber 150 down to a desired value creating an inert vacuum condition in the chamber. The pressure sensor 104 monitors a pressure of the air-tight crushing chamber 150. In some embodiments, the pressure sensor 104 sends a signal to an ECU 105. The pre-conditioning chamber 201 may be loaded with the batteries 113 by opening the pre-conditioning chamber inlet door 202 while the pre-conditioning chamber outlet door 203 is closed. After the batteries 113 are loaded, the pre-conditioning chamber inlet door 202 is closed. In some embodiments, once the pre-conditioning chamber 201 is loaded with the batteries 113 and the pre-conditioning chamber inlet door 202 is closed, the valve 211 may be opened and the vacuum compressor 213 may be turned on to drive a stream of dry air 210 through the pre-conditioning chamber 201, to clean, purge, and dry the loaded lithium batteries 113. After the chamber is purged and/or dried, the pre-conditioning chamber valve 211 may be closed while the vacuum compressor 213 runs, reducing the pressure inside the pre-conditioning chamber 201, thus removing oxygen content from the pre-conditioning chamber 201. Upon reaching a desired pressure (equilibrated with the vacuum conditions of the crushing chamber 150 so the outlet door 203 may open freely) and/or oxygen content inside the pre-conditioning chamber 201, the pre-conditioning chamber outlet door 203 may be opened, dropping the batteries 113 into the air-tight crushing chamber 150. The batteries 113 may then be crushed and/or shredded by the crusher 101 in the air-tight crushing chamber 150, crushing the batteries 113 into a quantity of comminuted material 107, the comminuted material comprised of black mass and crushed chips. This process may be repeated to enable a semi-continuous crushing process.

A conduit pipe 151 has a first end in fluid communication to the air-tight crushing chamber 150 and a second end in fluid communication to a solvent recovery unit 400. The conduit pipe 151 comprises a conduit valve 106 between the air-tight crushing chamber 150 and the solvent recovery unit 400. The solvent recovery unit 400 comprises a vacuum compressor, which pulls the pressure of the air-tight crushing chamber 150 down to a desired value. A pressure sensor 104 may be connected in fluid communication to the air-tight crushing chamber 150 or the conduit pipe 151. The pressure sensor 104 monitors a pressure of the air-tight crushing chamber 150. In some embodiments, the pressure sensor 104 sends a signal to an ECU 105.

The semi-continuous operation processing system 600 also comprises a post-processing unit 250 fixed to the air-tight crushing chamber 150. According to some embodiments, the post-processing unit 250 is positioned to receive the comminuted material 107 from the crusher 101. According to some embodiments, the post-processing unit 250 is located under the crusher 101, the post-processing unit 250 receiving the comminuted material 107 from the crusher 101 as it falls.

According to some embodiments, the post-processing unit 250 comprises a post-processing inlet door 207 to a post-processing chamber 206. The post-processing inlet door 207 may open to receive the comminuted material 107 into the post-processing chamber 206. In some embodiments the post-processing chamber 206 also comprises a post-processing chamber outlet door 208. After comminuted material 107 is received in the post-processing chamber 206, the post-processing chamber inlet door may be closed, and the post-processing chamber valve 209 may be opened to purge the post-processing chamber 206 with cleaned inert gas from the solvent recovery unit 400 to bring the pressure to ambient conditions. Then, the post-processing chamber outlet door 208 may freely open to ambient atmosphere for the comminuted material 107 to be discharged from the semi-continuous operation processing system 600. In some embodiments, the post-processing inlet door 207 and the post-processing chamber outlet door 208 open and close in sequence, enabling the crushing system to work in a semi-continuous mode. A vacuum line and valve may exist between the post-processing chamber 206 to conduit pipe 151 (not pictured), so that the post-processing chamber may be vacuumed. With the pressure of the crushing chamber and the post-processing chamber equilibrated, the post-processing chamber inlet door 207 can be opened so that post-processing chamber 206 can receive more material as part of a semi-continuous process. In some embodiments, the ECU 105 electronically controls one or more of the following: the post-processing chamber inlet door 207, the post-processing chamber outlet door 208, the pre-conditioning chamber outlet door 203, pre-conditioning chamber inlet door 202, the post-processing valve 209, and the pre-conditioning chamber valve 211.

According to some embodiments, the post-processing unit 250 comprises a conveyor unit 205. According to some embodiments, the conveyor unit 205 is a heated conveyor unit. In some embodiments, upon opening the pre-conditioning chamber outlet door 203, the batteries 113 may be dropped into the air-tight crushing chamber 150, and the crusher 101 crushes and/or shreds the batteries 113 into comminuted materials 107. The comminuted materials 107 may then drop onto the conveyer unit 205 of the post-processing unit 250. The conveyer unit 205 may then transfer the comminuted material 107 into the post-processing chamber 206, where they may be discharged in batches through the post-processing chamber outlet door 208.

In some embodiments, a stream of inert gas may be introduced below the conveyer unit 205. The inert gas may purge the comminuted material 107, which has been heated by the heated conveyer unit 205 to a target temperature to vaporize one or more solvent chemicals in some embodiments. For example, in some embodiments the heated conveyor unit 205 may heat the comminuted material 107 to 200° C. In some embodiments, the inert gas may carry the vapor of the solvent chemicals into the solvent recovery unit 400, where the solvent chemical vapors may be condensed into solvent liquid and recovered.

### Secondary Semi-Continuous Operation Processing System

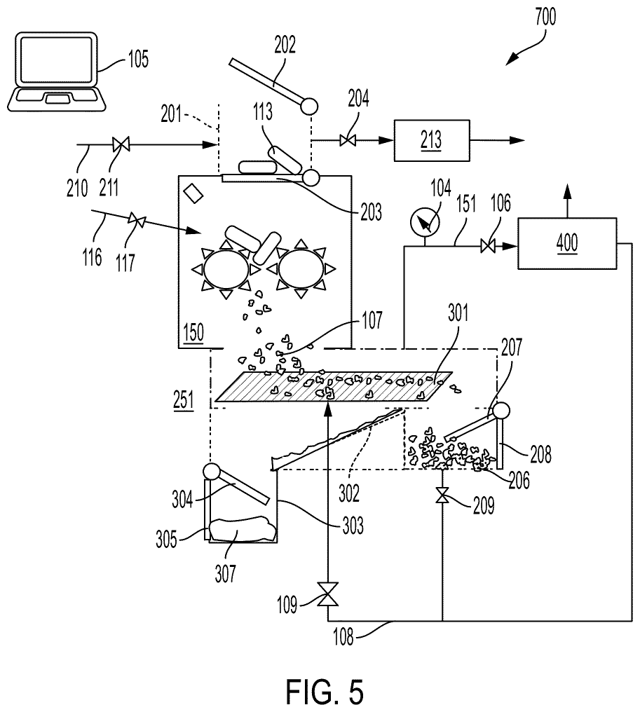

FIG. 5 shows an embodiment of an exemplary secondary semi-continuous operation processing system 700 for processing batteries 113 and collecting and recycling solvent chemicals. In some embodiments, the secondary semi-continuous operation processing system 700 may be similar or identical to the semi-continuous operation processing system 600, with a shaker post-processing unit 251 replacing the post-processing unit 250. In this embodiment, the conveyer unit 205 may be replaced by a shaker table 301. In some embodiments, the shaker table 301 is a heated shaker table 301. In some embodiments, the shaker table 301 shakes in horizontal directions in asymmetric cycles, thus transferring the comminuted material 107 from left to right in FIG. 5 into the post processing chamber 206. In some embodiments, smaller and/or lighter particles of the comminuted material may drop from the side of shaker table 301 onto a sloped surface 302. In some embodiments, the sloped surface 302 is heated. In some embodiments, the smaller and/or lighter comminuted material 107 slides down the sloped surface 302 and drops in a black mass collection chamber 303. In some embodiments, the black mass collection chamber 303 may have a black mass chamber inlet door 304 and a black mass chamber outlet door 305 that open/close alternatively to allow the collected black mass 307 be discharged in the same or similar manner as the post-processing chamber inlet door 207 and the post-processing chamber outlet door 208 of the secondary semi-continuous operation processing system 700. In some embodiments, black mass collection chamber 303 also has purge and vacuum lines connected (not pictured), similar or identical to those described for post-processing chamber 206, so that the entry door 304 and outlet door 305 may open and close in communication with the crushing chamber without perturbing the vacuum conditions or allowing oxygen to enter the inert environment.

### Tertiary Semi-Continuous Operation Processing System

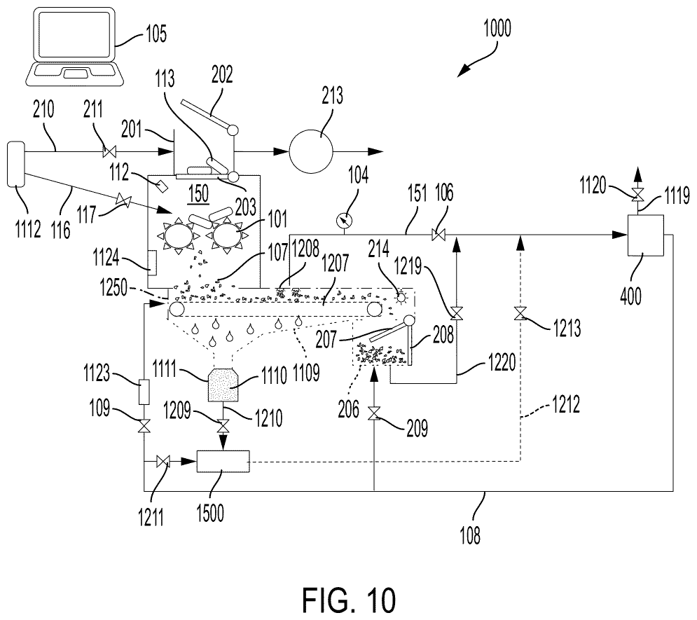

FIG. 10 shows a tertiary semi-continuous operation processing system 1000 for processing batteries 113 and collecting and recycling electrolyte mixes, according to some embodiments. According to some embodiments, the tertiary semi-continuous operation processing system 1000 comprises a crusher 101 similar to that of the primary batch operation processing system 100. In some embodiments, the crusher 101 of the tertiary semi-continuous operation processing system 1000 of FIG. 10 runs continuously. The tertiary semi-continuous operation processing system 1000 may also comprise a batch-operated pre-conditioning chamber 201 according to some embodiments. In some embodiments, the pre-conditioning chamber 201 may comprise a pre-conditioning chamber inlet door 202 on a first side of the pre-conditioning chamber 201 and a pre-conditioning chamber outlet door 203 on a second side of the pre-conditioning chamber 201. The pre-conditioning chamber inlet door 202 enables the pre-conditioning chamber 201 to open to ambient air for loading batteries 113 into the pre-conditioning chamber 201. The pre-conditioning chamber 201 may be fixed to an air-tight crushing chamber 150 such that the pre-conditioning chamber outlet door 203 is shared between the pre-conditioning chamber 201 and the air-tight crushing chamber 150. In some embodiments, the air-tight crushing chamber 150 comprises a crusher 101. The tertiary semi-continuous operation processing system 1000 may further comprise a source of inert gas 210 from inert gas source 1112 fluidically coupled to the pre-conditioning chamber 201 via a pre-conditioning chamber valve 211. The internal volume of the pre-conditioning chamber 201 may also be in fluid communication with vacuum compressor 213. In some embodiments, the vacuum compressor 213 draws a gas from an opposing side of the pre-conditioning chamber 201 from the pre-conditioning chamber valve 211.

The pre-conditioning chamber 201 may be loaded with the batteries 113 by opening the pre-conditioning chamber inlet door 202 while the pre-conditioning chamber outlet door 203 is closed. After the batteries 113 are loaded, the pre-conditioning chamber inlet door 202 is closed. In some embodiments, once the pre-conditioning chamber 201 is loaded with the batteries 113 and the pre-conditioning chamber inlet door 202 is closed, the pre-conditioning chamber valve 211 may be opened and vacuum compressor 213 may be turned on to drive a stream of dry air or inert gas 210 through the pre-conditioning chamber 201, to clean, purge, and dry the loaded lithium batteries 113. After the chamber is purged and/or dried, the pre-conditioning chamber valve 211 may be closed while vacuum compressor 213 runs, reducing the pressure inside the pre-conditioning chamber 201, thus removing oxygen content from the pre-conditioning chamber 201. Upon reaching a desired pressure and/or oxygen content inside the pre-conditioning chamber 201, the pre-conditioning chamber outlet door 203 may be opened, dropping the batteries 113 into the air-tight crushing chamber 150.

As described for the batch operation, the crushing chamber 150 may be pre-conditioned by purging with inert gas 116 by opening valve 117. Turning on the vacuum compressor inside of solvent recovery unit 400 pulls the pressure of the air-tight crushing chamber 150 down to a desired value. A pressure sensor 104 may be connected in fluid communication to the air-tight crushing chamber 150 or the conduit pipe 151. The pressure sensor 104 monitors a pressure of the air-tight crushing chamber 150. In some embodiments, the pressure sensor 104 sends a signal to an ECU 125. The pressure of the pre-conditioning chamber 201 and the crushing chamber may be equilibrated so that the preconditioning outlet door 203 may open freely. The pre-conditioning chamber outlet door 203 may be opened, dropping the batteries 103 into the air-tight crushing chamber 150. To prepare for the next batch of batteries, the pre-conditioning outlet door 203 is closed, vacuum compressor 213 is turned off, and pre-conditioning chamber valve 211 is opened to bring the pre-conditioning chamber 201 back to ambient pressure with inert gas 116.

The batteries 113 may then be crushed and/or shredded by the crusher 101 in the air-tight crushing chamber 150, crushing the batteries 113 into a quantity of comminuted material 107, the comminuted material comprised of black mass and crushed chips. This process may be repeated to enable a semi-continuous crushing process. In some embodiments, the black mass and the crushed chips are heated to a desired temperature by a heater 1124.

The tertiary semi-continuous operation processing system 1000 may further comprise a post-processing unit 250 fluidically coupled to the air-tight crushing chamber 150. According to some embodiments, the post-processing unit 250 is positioned to receive the comminuted material 107 from the crusher 101. According to some embodiments, the post-processing unit 250 is located under the crusher 101, the post-processing unit 250 receiving the comminuted material 107 from the crusher 101 as it falls. In some embodiments, post-processing unit 1250 comprises of a conveyance unit 1207 that carries the comminuted materials 107 to the post-processing chamber 206. According to some embodiments, the conveyance unit 1207 is a heated conveyor unit.

In some embodiments, the post-processing unit 250 further comprises a working liquid sprayer 1208 configured to dispense a liquid onto the comminuted material 107 to wash residual electrolyte off. In some embodiments, the post-processing unit 1250 further comprises a post-processing heater 214 configured to heat the comminuted material 107 and work to evaporate any working liquid or chemical solvents.

According to some embodiments, comminuted material 107 exiting the post-processing unit 250 passes through a post-processing inlet door 207 to a post-processing chamber 206 held at an equilibrated pressure to the crushing chamber 150 and post-processing unit 1250. To achieve equilibrated pressure, the post-processing chamber output valve 1219 may be open to flow air/gas out via the post-processing chamber vacuum line 1220 utilizing the vacuum compressor in the solvent recovery unit 400. The post-processing inlet door 207 may open to receive the comminuted material 107 into the post-processing chamber 206. In some embodiments the post-processing chamber 206 also comprises a post-processing chamber outlet door 208. The post-processing chamber inlet door 207 may be shut, and the post processing chamber input valve 209 may be opened to flow inert gas to the post-processing chamber 206 to bring the pressure back to ambient conditions, while maintaining vacuum conditions inside of the crushing chamber 150 and post processing unit 250. The post-processing chamber outlet door 208 may open to ambient atmosphere for the comminuted material 107 to be discharged from the tertiary semi-continuous operation processing system 1000. In some embodiments, the post-processing inlet door 207 and the post-processing chamber outlet door 208 open and close in sequence, enabling the crushing system to work in a semi-continuous mode. In some embodiments, the ECU 105 electronically controls one or more of the following: the post-processing chamber inlet door 207, the post-processing chamber outlet door 208, the pre-conditioning chamber outlet door 203, pre-conditioning chamber inlet door 202, the post-processing chamber input valve 209, and the pre-conditioning chamber valve 211.

According to some embodiments, the post-processing unit 250 comprises a conveyor unit 205. According to some embodiments, the conveyor unit 205 is a heated conveyor unit. In some embodiments, upon opening the pre-conditioning chamber outlet door 203, the batteries 113 may be dropped into the air-tight crushing chamber 150, and the crusher 101 crushes and/or shreds the batteries 113 into comminuted materials 107. The comminuted materials 107 may then drop onto the conveyer unit 205 of the post-processing unit 250. The conveyer unit 205 may then transfer the comminuted material 107 into the post-processing chamber 206, where they may be discharged in batches through the post-processing chamber outlet door 208.

In some embodiments, a temperature of the dry inert gas 108 that passes through the separation unit valve 109 is regulated by a temperature regulator 1123. In some embodiments, the solvent recovery unit 400 further comprises a vent line 1119 and a vent valve 1120 to exhaust gas in the solvent recovery unit 400.

In some embodiments, the air-tight crushing chamber 150 comprises a temperature sensor 112. In some embodiments, the temperature sensor 112 may be an infrared camera, infrared temperature sensor, or other electronic temperature sensor. The temperature sensor 112 is installed inside the air-tight chamber to monitor the temperature of the batteries 113 being crushed and/or shredded. In some embodiments, a temperature signal is transmitted to the ECU 105 to monitor any potential fire hazard. In some embodiments, if the temperature in the crushing zone is higher than a maximum allowable value, e.g., the lowest chemical decomposition temperature, the ECU 105 opens the air-tight chamber valve 117, which allows a controlled stream of a cold, compressed inert gas 116 from an inert gas source 1112 to jet onto the crushing zone, thus reducing the temperature at the crushing zone below a maximum allowable value.

In some embodiments, a stream of inert gas may be introduced below the conveyer unit 1208. The inert gas may purge the comminuted material 107, which has been heated by the heated conveyer unit 205 to a target temperature to vaporize one or more solvent chemicals in some embodiments. For example, in some embodiments the heated conveyor unit 205 may heat the comminuted material 107 to 200° C. In some embodiments, the inert gas may carry the vapor of the solvent chemicals into the solvent recovery unit 400, where the solvent chemical vapors may be condensed into solvent liquid and recovered.

In some embodiments, the conveyor unit is equipped with a filter that allows droplets of electrolyte mix 1110 that cannot be vaporized quickly enough to fall through. This is also used to catch excess working liquid spray 208. The total electrolyte mix 1110 may be guided by a funnel 1109 into a storage vat 1111.

### Quaternary Semi-Continuous Operation Processing System

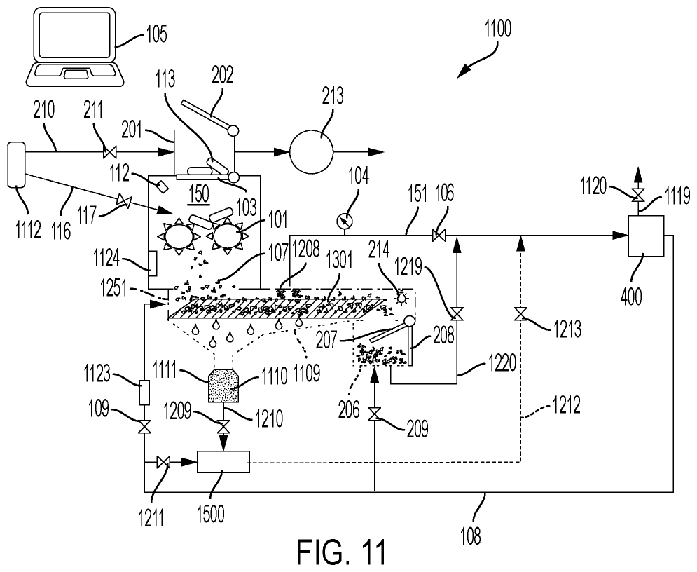

FIG. 11 shows an embodiment of an exemplary quaternary semi-continuous operation processing system 1100 for processing batteries 113 and collecting and recycling solvent chemicals. In some embodiments, the quaternary semi-continuous operation processing system 1100 may be similar or identical to the tertiary semi-continuous operation processing system 1000, with a shaker post-processing unit 1251 replacing the post-processing unit 1250. In this embodiment, the conveyer unit 1207 may be replaced by a shaker table 1301. In some embodiments, the shaker table 1301 is a heated shaker table 1301. In some embodiments, the shaker table 1301 shakes in horizontal directions in asymmetric cycles, thus transferring the comminuted material 107 from left to right in FIG. 11 into the post processing chamber 206. In some embodiments, a storage vat is used to collect electrolyte mix and excess working liquid spray that seeps through the shaker table as described for the tertiary semi-continuous operation processing system previously.

### Quinary Semi-Continuous Operation Processing System

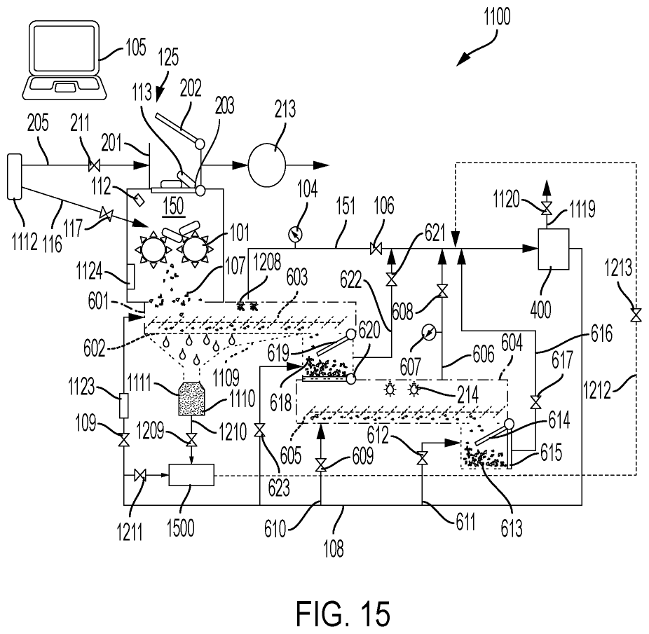

FIG. 15 shows an embodiment of an exemplary quinary semi-continuous operation processing system 1600 for processing batteries 113 and collecting and recycling solvent chemicals. In some embodiments, the quinary semi-continuous processing system 1600 may be similar or identical to the primary 600, secondary 700, tertiary 1000, and/or quaternary 1100 semi-continuous processing system. In some embodiments, the post processing unit is broken into two units to separate washing and drying capabilities.

The first unit could be a washing unit 601 with washing nozzles 1208 used to rinse the black mass of any electrolyte, similar to the tertiary and quaternary semi-continuous operating systems. Attached to the washing unit 601 is a post-washing chamber 618, with entry door 619 and outlet door 620, where the screw conveyor 603 or other conveyance unit can carry the comminuted materials 107 to. The post-washing chamber 618 can be vacuumed by opening post-washing chamber vacuum valve 621 on post-washing chamber vacuum line 622. This can be used to equilibrate the pressure of the post-washing chamber 618 to that of the crushing chamber 150, allowing the post-washing entry door 619 to open freely. Following this, the post-washing entry door 619 may be shut, and the post-washing purge valve 623 may be opened if a different pressure is desired in the post-washing chamber 618 to allow the post-washing chamber outlet door 620 to open. In some embodiments, the gas stream may be heated or cooled to allow for additional temperature control.

The second unit could be a drying unit 604 with heaters 214 used to dry the comminuted materials 107 of any residual working liquid or solvents. In some embodiments, the drying unit 604 may comprise of a secondary screw conveyor 605 or other conveyor. Attached to the drying unit 604 could be a post-drying chamber 613, with entry door 614 and outlet door 615, where the secondary screw conveyor 605 carries material to. The post-drying chamber 613 can be vacuumed by opening post-drying chamber vacuum valve 617 on post-drying chamber vacuum line 616 or purged with inert gas by opening post-drying purge valve 612. This can be used to equilibrate the pressure of the post-drying chamber 613 to that of the drying unit 604, allowing the post-washing entry door 614 to open freely. In some embodiments, the gas stream may be heated or cooled to allow for additional temperature control.

Altogether, this allows the post-washing chamber 618 and post-drying chamber 613 to process the comminuted material 107 at different pressures and temperatures. In some embodiments, a screw conveyor 603 is utilized to simultaneously tumble and wash the comminuted material with working liquids from nozzles 1208.

The drying unit 604 uses a heat source 214 to heat the comminuted material as it moves through the chamber via the secondary screw conveyor 605. In some embodiments, the heat source may be conductive from oil, steam, electric, gas, etc., or radiative from infrared light or other electric sources. In some embodiments, the secondary screw conveyor 605 may be replaced another means of transporting the material with agitation such as a tumbler, paddles, vibration, etc. In some embodiments, the drying chamber 604 is at a lower pressure and/or a higher temperature to aid in the drying process. In some embodiments, post washing chamber 618 and post drying chamber 613 and supporting equipment may be replaced by a pressure retaining valve such as a double dump valve, rotary valve, etc.

To release the washed and dried comminuted materials, the post-drying entry door 614 is closed, and the post-drying purge valve 612 is opened to bring the pressure up to ambient conditions, if it is at that point sub-ambient. The post-drying outlet door 615 may be opened and the materials may be collected.

### Methods of Recycling a Battery

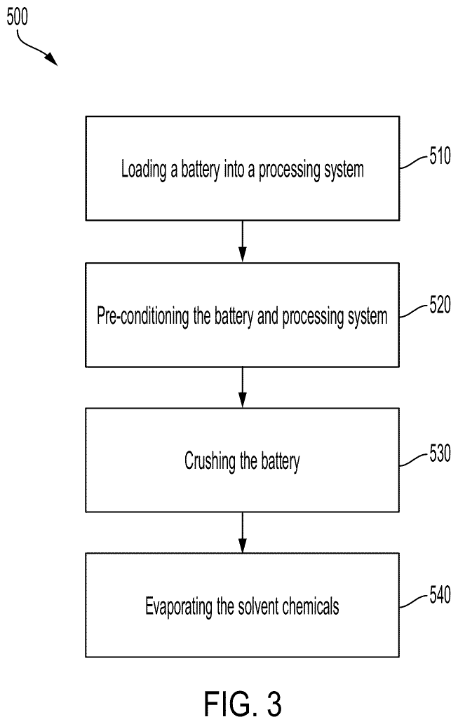

FIG. 3 shows a primary method 500 of processing batteries in batches and collecting and recycling solvent chemicals, according to some embodiments. At 510, batteries are loaded into the crusher. According to some embodiments, a separation unit door is opened and comminuted material may also be released from the separation unit through the separation unit door. At 510, the conduit valve is shut off, as well as the chamber valve and the separation unit valve before the entry door is opened to load batteries into the crusher. According to some embodiments, the crusher is also turned off before batteries are loaded.

At 520, the batteries are preconditioned. According to some embodiments, the batteries are preconditioned by cleaning, purging, and drying the batteries. The air-tight crushing chamber is also pulled to a desired vacuum condition after the entry door and the outlet door are closed. In some embodiments, pulling the air-tight crushing chamber to a desired vacuum condition involves opening the conduit valve and the separation unit valve. In some embodiments, a dry inert gas is passed through the system. In some embodiments, the dry inert gas is passed through the system to purge and dry the batteries until the batteries are dry and the pressure in the air-tight chamber is pulled down to a desired value. In some embodiments, the separation unit valve is controlled by the ECU such that the vacuum inside the system is kept at a constant level, e.g., 0.05 atm.

At 530, the batteries are crushed and/or shredded under regulated temperature and vacuum conditions by the crusher in the airtight chamber. During this step, the temperature of the heating unit is regulated to a designated value and/or the pressure is regulated to a designated value in some embodiments. For example, in some embodiments, the temperature of the heating unit is regulated to 40° C. and the pressure in the airtight chamber is regulated to 0.05 atm. The crusher is then turned on, which crushes/shreds the batteries into comminuted material. The comminuted material is dropped on the separation unit, where the small particle black mass is partially separated from the large particle crushed chips. The black mass and the crushed chips are heated to a desired temperature. In some embodiments, the black mass and the crushed chips are heated to a desired temperature by a heater 111. In some embodiments, the black mass and the crushed chips are heated to a temperature above the boiling points of some or all electrolyte solvents at the lowered pressure, resulting in the electrolyte solvents evaporating away from the crushed solids. The evaporated electrolyte solvents are then carried through the conduit pipe to the solvent recovery unit. In some embodiments, a stream of inert gas may flow through the separation unit and carry the solvent vapors to the solvent recovery unit 400, where the evaporated solvents are then condensed and recovered. In some embodiments, airborne contaminants comprising particulates and/or vapor, are also carried to the solvent recovery unit 400, where they are contained and recovered by filtration of particulates and/or condensation of vapor.

At 540, the remaining evaporated solvents are collected and condensed after all the batteries are crushed/shredded. In some embodiments, the crusher is stopped. In some embodiments, the inert gas continues to carry evaporated solvent chemicals to the solvent recovery unit, until most of the solvent chemicals are evaporated/recovered, and/or the airborne contaminants/dusts are completely purged and removed. At this time, the system should be contaminant free and ready for the next batch of operation, starting from 510.

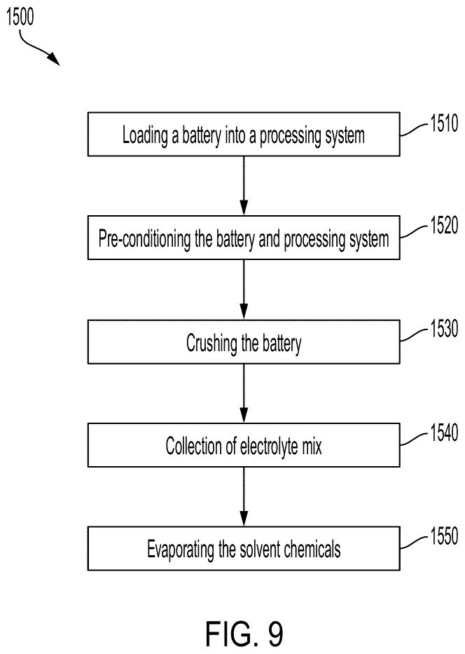

FIG. 9 shows a secondary method 1500 of processing batteries in batches and collecting and recycling solvent chemicals, according to some embodiments. At 1510, batteries are loaded into the crusher. According to some embodiments, a separation unit door is opened and comminuted material may also be released from the separation unit through the separation unit door. At 1510, the conduit valve is shut off, as well as the chamber valve and the separation unit valve before the entry door is opened to load batteries into the crusher. According to some embodiments, the crusher is also turned off before batteries are loaded.

At 1520, the batteries are preconditioned. According to some embodiments, the batteries are preconditioned by cleaning, purging, and drying the batteries. The air-tight crushing chamber is also pulled to a desired vacuum condition after the entry door and the outlet door are closed. In some embodiments, pulling the air-tight crushing chamber to a desired vacuum condition involves opening the conduit valve and the separation unit valve. In some embodiments, a dry inert gas is passed through the system. In some embodiments, the dry inert gas is passed through the system to purge and dry the batteries until the batteries are dry and the pressure in the air-tight chamber is pulled down to a desired value. In some embodiments, the separation unit valve is controlled by the ECU such that the vacuum inside the system is kept at a constant level, e.g., 0.05 atm.

At 1530, the batteries are dropped into the crushing chamber and crushed and/or shredded under regulated temperature and vacuum conditions by the crusher in the airtight chamber. During this step, the temperature of the heating unit is regulated to a designated value and/or the pressure is regulated to a designated value in some embodiments. For example, in some embodiments, the temperature of the heating unit is regulated to 40° C. and the pressure in the airtight chamber is regulated to 0.05 atm. The crusher is then turned on, which crushes/shreds the batteries into comminuted material. The comminuted material is dropped on the separation unit, where the small particle black mass is partially separated from the large particle crushed chips. The black mass and the crushed chips are heated to a desired temperature. In some embodiments, the black mass and the crushed chips are heated to a temperature above the boiling points of some or all electrolyte solvents at the lowered pressure, resulting in the electrolyte solvents evaporating away from the crushed solids. The evaporated electrolyte solvents are then carried through the conduit pipe to the solvent recovery unit. In some embodiments, a stream of inert gas may flow through the separation unit and carry the solvent vapors to the solvent recovery unit 400, where the evaporated solvents are then condensed and recovered. In some embodiments, airborne contaminants comprising particulates and/or vapor, are also carried to the solvent recovery unit 400, where they are contained and recovered by filtration of particulates and/or condensation of vapor.

At 1540, the working liquid sprayers are turned on. The comminuted materials are rinsed with the working liquid to wash away any residual electrolyte salt that could cause HF production in later processing steps. The excess working liquid and electrolyte mix is guided down to a storage vat via funnel for later processing. A series of filters may be set in place before the vat to catch any fine solid particles such as black mass to ensure the storage vat consists of liquid solutions only.

At 1550, the heaters in the post-processing chamber are turned on and the remaining evaporated solvents are collected and condensed after all the batteries are crushed/shredded. In some embodiments, the crusher is stopped. In some embodiments, the inert gas continues to carry evaporated solvent chemicals to the solvent recovery unit, until most of the solvent chemicals are evaporated/recovered, and/or the airborne contaminants/dusts are completely purged and removed.

### Primary Solvent Recovery Units

FIG. 6 shows a primary first solvent recovery unit 400A for collecting and recycling solvent chemicals, according to some embodiments. The primary first solvent recovery unit 400A may comprise a solvent condensation unit 402, a particulate filtration unit 403, a compressor 404, and an inert gas storage tank 405. In some embodiments, the solvent condensation unit 402 is in fluid communication with a first conduit 401, which connects the primary first solvent recovery unit 400A to the air-tight crushing chamber 150, the post-processing unit 250 according to some embodiments. The solvent condensation unit 402 may have a second conduit in fluid connection to the solvent condensation unit 402, which connects to a particulate filtration unit 403 before connecting to the compressor 404. In some embodiments, the solvent condensation unit 402 may have one or more solvent chemical collectors 412a, 412b, 412c. In some embodiments, each solvent chemical collector 412a, 412b, 412c collects a different solvent chemical.

In an embodiment, the compressor 404 draws an inert gas stream from the air-tight crushing chamber 150, the post-processing unit 250 through the first conduit 401 carrying the solvent chemical vapors into the solvent condensation unit 402, where it is cooled, and the solvent chemical vapors may be condensed, and collected by the solvent chemical collectors 412a, 412b, 412c. In some embodiments, the chemicals are distilled and/or separated before collecting in the solvent chemical collectors 412a, 412b, 412c. In some embodiments, a cooling unit 411 is installed inside the solvent condensation unit 402 to further cool the gas stream to a lower temperature, which may result in less amount of vapor being carried out from the condensation unit. The remaining inert gas stream may then be pulled through the filtration unit 403 before passing through the compressor 404 and compressed into an inert gas storage tank 405. The remaining inert gas stored in the inert gas storage tank 405 may then be recycled and reused as the inert gas purge stream 108 for the crushing system according to some embodiments. In some embodiments, if the pressure in the inert gas storage tank 405 exceeds a designated maximum pressure value, e.g., 20 psi, a pressure relief value valve 410 may be opened to allow excessive inert gas to be releases to the ambient atmosphere.

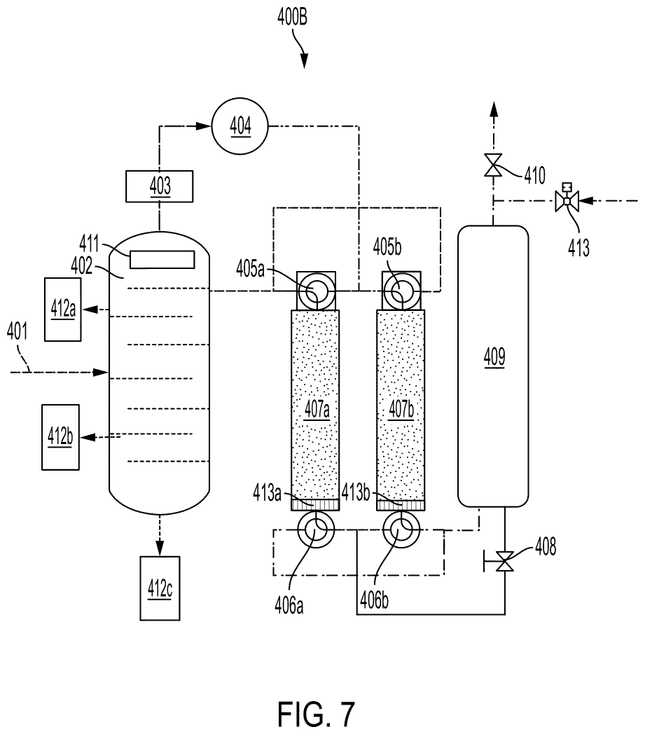

FIG. 7 shows a primary second solvent recovery unit 400B for processing batteries 113 and collecting and recycling solvent chemicals comprising all components as shown in FIG. 6, with the addition of a cyclic adsorption unit. In some embodiments, the adsorption unit may comprise two adsorbent beds 407a and 407b, three-way valves 405a, 405b, 406a, 406b, and a flow control valve 408. In some embodiments, the inert gas stream drawn from the condensation unit 402 may be compressed into a high-pressure stream and pushed through the adsorbent bed 407b, where residual solvent chemicals may be adsorbed by the sorbent materials packed in the bed 407b. The inert gas stream may then be compressed into the inert gas storage tank 409, according to some embodiments. In some embodiments, a stream of inert gas may be expelled from the inert gas storage tank 409 through the flow controlling valve 408 through the sorbent bed 407a, which is under vacuum pressure, and purge desorbed chemical vapors back into the vapor condensation unit 402, regenerating the sorbent bed 407a. In some embodiments, a heating element 413 may heat the beds 407a, 407b to a targeted elevated temperature, thus enhancing the regeneration process.

For a certain period, valves 405a, 405b, 406a, 406b are switched, and sorbent bed 407a is used as an adsorption bed while sorbent bed 407b is being purged and regenerated. These processes repeat at a constant pace thus forming a cyclic adsorption unit. In some embodiments, the valves 405a, 405b, 406a, 406b are controlled electronically by an ECU 105.

In some embodiments, all, none, or any of the various valves, compressors, conveyor belts, shaker tables, heating elements, temperature sensors, pressure sensors, doors any other component, sensor, or element may be electronically controlled in any combination by the ECU 105.

### Secondary Solvent Recovery Units

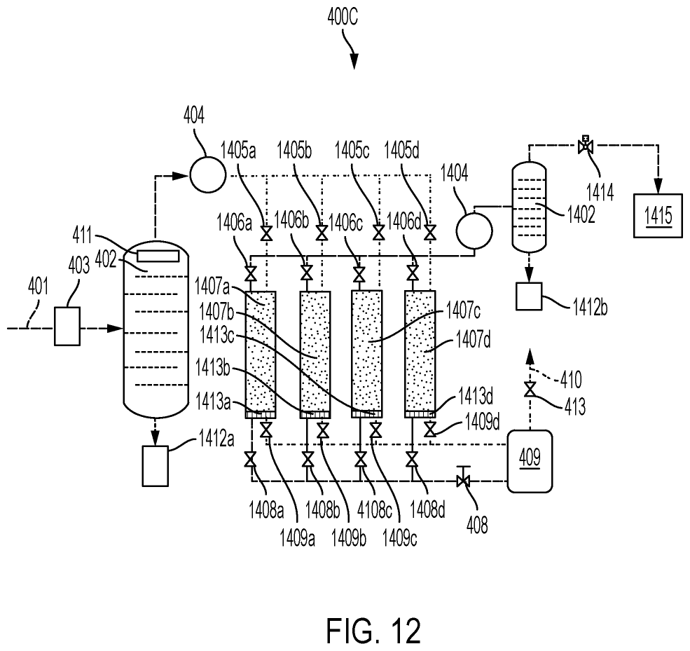

FIG. 12 shows an exemplary secondary solvent recovery unit 400C for processing batteries. As shown, in some embodiments, the secondary solvent recovery unit 400C comprises a particulate filtration unit 403, a first compressor 404, a second compressor 1404, a first solvent condensation unit 402, a second solvent condensation unit 1402, a cooling unit 411, a first solvent chemical collector 1412A, a second solvent chemical collector 1412B, an inert gas storage tank 409, adsorbent beds 1407A 1407B 1407C 1407D, heating elements 1413A 1413B 1413C 1413D, and a thermal oxidizer 1415.

In some embodiments, the first compressor 404 draws a solvent from the particulate filtration unit 403 into the first solvent condensation unit 402, wherein solvent condensed by the cooling unit 411 flows to the first solvent chemical collector 1412a. In some embodiments, the vacuum compressor 404 may be on either side of the solvent condensation unit 402. In some embodiments, gaseous solvent flows from the first solvent condensation unit 402 to a first adsorbent bed 1407A, where the solvent vapor is adsorbed by the adsorption bed leaving a stream of clean inert gas to pass through to the inert gas storage tank 409. Once the adsorption phase is complete the valves are then switched to regenerate adsorption bed 1407A such that the vacuum compressor 1404 draws vacuum to desorb the solvent vapor adsorbed by the first adsorbent bed 1407A, while a clean stream of inert gas is allowed to flow from inert gas storage tank 409 to act as a carrier gas. In some embodiments, the adsorbent beds are cycled such that each bed will undergo an adsorption and regeneration phase forming a cyclic process. In some embodiments, there may be any number of beds connected to the system performing the cyclic adsorption process. In some embodiments, the first adsorbent bed 1407A, the second adsorbent bed 1407B, the third adsorbent bed 1407C, and the fourth adsorbent bed 1407D, are individually heated by a first heater 1413A, a second heater 1413B, a third heater 1413C, and a fourth heater 1413D, respectively. In some embodiments, the heaters 1413A 1413B 1413C 1413D heat the beds 1407A 1407B 1407C 1407D to a targeted elevated temperature, thus enhancing the regeneration process.

In some embodiments, the vapors drawn by vacuum compressor 1404 from the first adsorbent bed 1407A, the second adsorbent bed 1407B, the third adsorbent bed 1407C, and the fourth adsorbent bed 1407D are pushed into the second solvent condensation unit 1402, wherein condensed solvent flows to the second solvent chemical collector 1412b. In some embodiments, the second condensation unit 1402 is at a higher pressure and/or lower temperature than the first condensation unit 402 to enhance solvent recovery by improving the condensation conditions for the vapor. According to some embodiments, the condenser tanks 402 and 1402 are connected to the distillation unit 1500 for single collection of all liquids recovered from batteries. In some embodiments, the first adsorbent bed 1407A, the second adsorbent bed 1407B, the third adsorbent bed 1407C, and the fourth adsorbent bed 1407D are fluidically coupled to the second compressor 1404 via individually controllable valves. In some embodiments, gas exiting the second condenser 1402 is transported to the thermal oxidizer 1415 via a pressure regulating valve 1414.

### Distillation Unit

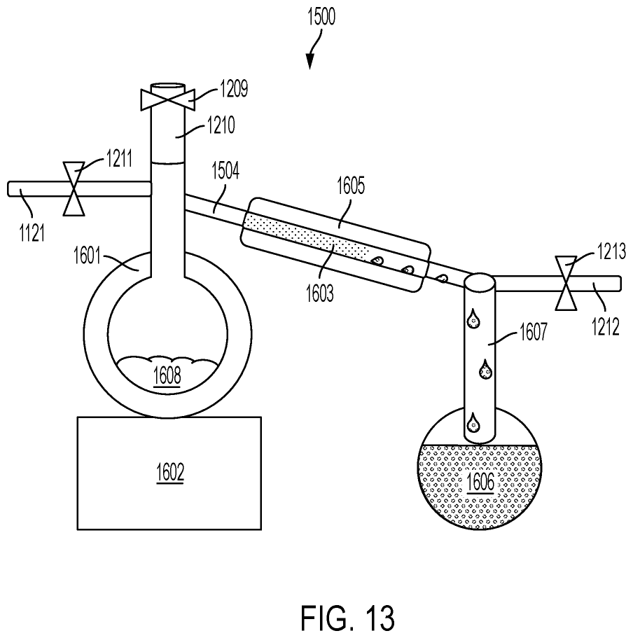

FIG. 13 shows an illustration of a distillation unit according to some embodiments. The electrolyte mix 1110 stored in vat 1111 is dropped or pumped through distillation pipe 1210 into an insulated storage vat 1601 as distillation purge valve 1211 is closed and distillation connection point 1209 is open. In some embodiments, distillation connection point 1209 is a valve, pump, etc. In different embodiments, distillation vacuum valve 1213 may be an on/off valve to achieve vacuum or be a pressure relief valve. Distillation connection point 1209 can then be closed, and the insulated storage vat 1601 is heated by distillation heater 1602 to a designated temperature, above the boiling points of the solvents at a given pressure in the distillation unit 1500. Distilled vapors 1603 are pushed through vapor transfer pipe 1604 equipped with distillation condenser 1605. The vapors are condensed into liquid/droplets 1606 and sent to a secondary storage vat 1607. Electrolyte materials 1608 such as electrolyte salts are left in storage vat 1601. Distillation vacuum valve 1213 is shut off, and distillation purge valve 1211 is opened to purge the system with inert gas 108. Once brought to ambient pressure, distillation purge valve 1211 can be shut off and the insulated storage vat 1601 and secondary storage vat 1607 may be removed so the materials can be collected. The vats can be reattached, and the system is ready to receive the next batch of electrolyte mix 1110 as part of the semi-continuous process.

### Computer Control Systems

The present disclosure provides computer control systems that are programmed to implement methods of the disclosure. FIG. 8 shows a computer system 801 that is programmed or otherwise configured to control a method and system for recycling batteries. The computer system 801 can regulate various aspects of environmental control and timing in the processing system of the present disclosure, such as, for example, the computer system may time the various doors and valves of the processing system to control the timing and flow of processing batteries and regulate the environment inside the system. The computer may also receive readings from sensors in the system, such as the temperature sensor and the pressure sensor and use them in conjunction with the heating element, vacuum, and numerous valves to regulate the pressure and temperature inside of the processing system. The computer system 801 can be an electronic device of a user or a computer system that is remotely located with respect to the electronic device. The electronic device can be a mobile electronic device.

The computer system 801 includes a central processing unit (CPU, also “processor” and “computer processor” herein) 805, which can be a single core or multi core processor, or a plurality of processors for parallel processing. The computer system 801 also includes memory or memory location 810 (e.g., random-access memory, read-only memory, flash memory), electronic storage unit 815 (e.g., hard disk), communication interface 820 (e.g., network adapter) for communicating with one or more other systems, and peripheral devices 825, such as cache, other memory, data storage and/or electronic display adapters. The memory 810, storage unit 815, interface 820 and peripheral devices 825 are in communication with the CPU 805 through a communication bus (solid lines), such as a motherboard. The storage unit 815 can be a data storage unit (or data repository) for storing data. The computer system 801 can be operatively coupled to a computer network (“network”) 830 with the aid of the communication interface 820. The network 830 can be the Internet, an internet and/or extranet, or an intranet and/or extranet that is in communication with the Internet. The network 830 in some cases is a telecommunication and/or data network. The network 830 can include one or more computer servers, which can enable distributed computing, such as cloud computing. The network 830, in some cases with the aid of the computer system 801, can implement a peer-to-peer network, which may enable devices coupled to the computer system 801 to behave as a client or a server.

The CPU 805 can execute a sequence of machine-readable instructions, which can be embodied in a program or software. The instructions may be stored in a memory location, such as the memory 810. The instructions can be directed to the CPU 805, which can subsequently program or otherwise configure the CPU 805 to implement methods of the present disclosure. Examples of operations performed by the CPU 805 can include fetch, decode, execute, and writeback.

The CPU 805 can be part of a circuit, such as an integrated circuit. One or more other components of the system 801 can be included in the circuit. In some cases, the circuit is an application specific integrated circuit (ASIC).

The storage unit 815 can store files, such as drivers, libraries and saved programs. The storage unit 815 can store user data, e.g., user preferences and user programs. The computer system 801 in some cases can include one or more additional data storage units that are external to the computer system 801, such as located on a remote server that is in communication with the computer system 801 through an intranet or the Internet.

The computer system 801 can communicate with one or more remote computer systems through the network 830. For instance, the computer system 801 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 801 via the network 830.

Methods as described herein can be implemented by way of machine (e.g., computer processor) executable code stored on an electronic storage location of the computer system 801, such as, for example, on the memory 810 or electronic storage unit 815. The machine executable or machine readable code can be provided in the form of software. During use, the code can be executed by the processor 805. In some cases, the code can be retrieved from the storage unit 815 and stored on the memory 810 for ready access by the processor 805. In some situations, the electronic storage unit 815 can be precluded, and machine-executable instructions are stored on memory 810.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 801, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 801 can include or be in communication with an electronic display 835 that comprises a user interface (UI) 840 for providing, for example, controls and/or settings for running a batch continuous operation processing system 500 or a semi-continuous operation processing system 700 for processing batteries 113 and collecting and recycling solvent chemicals from the batteries 113. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 805. The algorithm can, for example, facilitate processing the batteries through the processing system by opening and closing doors and valves and regulating the temperature and pressure of the system by controlling the heating element and various valves, while receiving feedback from the temperature and pressure sensors.

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

### Terms and Definitions

The term “battery” as used herein, generally refers to any electric battery comprising liquid solvent chemicals, including but not limited to a “lithium battery,” to store energy.

The term “lithium battery” as used herein, generally refers to any electric battery containing lithium ions, compounds, or metal, alone or in combination with other chemicals and materials, to store energy and produce electricity.

The term “anode” as used herein, generally refers to the material part inside a battery and functions as the negative pole of the battery. The anode may store lithium in a lithium battery. The anode can be comprised of a material such as graphite, silicon, or any other material combinations, in some cases coated on Cu foil.

The term “cathode” as used herein, generally refers to the positive material part inside a battery and functions as the positive pole of the battery. The cathode may store chemicals that react with lithium to release energy. The cathode may be comprised of a combination of polymer binders (such as PVDF) and mixed metal oxide compounds, such as NCM (LiNiCoMnOx), LFP (LiFePO4), etc., in some cases coated on Al foil.

The term “vacuum condition” as used herein, generally refers to the condition for which an environment has reduced pressure, thus creating a vacuum.

The term “electrolyte” as used herein, generally refers to the chemical that can carry ions, including lithium ions in lithium batteries, and transport them between the anode and cathode, such as conducting salt (such as LiPF6) dissolved in a mix of organic carbonates (such as DMC, EC, PC, DEC, etc.)

The term “solvent” as used herein, generally refers to one or more electrolyte solvent chemical(s) in which the conducting salt(s) is dissolved. It can be a single chemical or a mixture of chemical compounds like organic carbonates.

The term “electrolyte mix” as used herein, generally refers to the mixture of electrolytes and solvents.

The term “crusher” as used herein, generally refers to any mechanical equipment with the ability to tear/break/cut the battery apart, e.g., a shredder, a crusher, a grinder, a cutter, or a mill.

The term “comminuted material” as used herein, generally refers to the materials parts generated by crushing the batteries. It contains all the raw solid and liquid materials that constitute the batteries.

The term “black mass” as used herein, generally refers to the materials in small particles separated from the comminuted material, typically containing the solids of anode, cathode, and conducting salt(s).

The term “crushed chips” as used herein, generally refers to the large particles/aggregates separated from the comminuted material, typically containing metal chips/foils, plastic chips/films, and other large particle substances like battery casing materials.

The term “ECU” as used herein, generally refers to an Electronic Controlling Unit, such as a computer, which collects various data from the system such as temperature, pressure, etc., and controls output devices such as valves, heaters, sensors, etc.

The term “separation unit” as used herein, generally refers to a device unit that separates the comminuted materials based on size or specific gravity of the constituent particles.

The term “inert gas” as used herein, generally refers to a gas that does not involve any chemical reaction in the system. This can be, for example, helium, argon, nitrogen or carbon dioxide.

The term “working liquid” as used herein, generally refers to a fluid that is used to wash or rinse the comminuted materials. For example, water, carbonate solvents, and/or other organic solvents.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1-80. (canceled)

81. A method of recycling a battery comprising a solvent chemical, comprising:
(a) loading the battery into a processing system;
(b) pre-conditioning the battery and the processing system;
(c) shredding the battery under a vacuum pressure; and
(d) recovering the solvent chemical.

82. The method of claim 81, wherein shredding the battery under the vacuum pressure is continuous.

83. The method of claim 81, wherein pre-conditioning the battery and the processing system is batched.

84. The method of claim 81, wherein pre-conditioning the battery and the processing system further comprises cleaning, purging, and drying the battery with a stream of dry air.

85. The method of claim 81, wherein pre-conditioning the battery and the processing system further comprises placing an internal volume of the processing system under the vacuum pressure.

86. The method of claim 81, wherein recovering the solvent chemical comprises evaporating the solvent chemical.

87. The method of claim 86, wherein evaporating the solvent chemical comprises heating the solvent chemical to a temperature above a boiling point of the solvent chemical under the vacuum pressure.

88. The method of claim 87, wherein the temperature is 40° C. or less.

89. The method of claim 87, wherein the temperature is 60° C. or less.

90. The method of claim 81, wherein shredding the battery generates a comminuted material and wherein recovering the solvent chemical further comprises heating and shaking the comminuted material.

91. The method of claim 90, wherein recovering the solvent chemical further comprises rinsing the comminuted material with a working liquid.

92. The method of claim 86, wherein recovering the solvent chemical further comprises condensing the solvent chemical into a liquid after evaporating the solvent chemical.

93. The method of claim 92, wherein condensing the solvent chemical into a liquid comprises pulling the solvent chemical into a condenser.

94. The method of claim 81, further comprising purging the processing system with an inert gas under the vacuum pressure.

95. The method of claim 93, wherein condensing the solvent chemical into the liquid further comprises providing the inert gas to the processing system, wherein the inert gas carries the recovered solvent chemical to the condenser.

96. The method of claim 94, further comprising maintaining the processing system at the vacuum pressure with the inert gas.

97. The method of claim 81, wherein the vacuum pressure is 0.05 atm or less.

98. The method of claim 94, wherein the inert gas comprises nitrogen, argon, or carbon dioxide.

99. The method of claim 81, further comprising recovering a plurality of solvent chemicals by heating the plurality of solvent chemicals according to a defined variable profile at a number of specific times, whereby at least one solvent chemical of the plurality of solvent chemicals are evaporated at the specific times.

100. A processing system for recycling a battery, comprising:
(a) a vacuum pump in fluid communication with a crusher chamber and configured to apply a vacuum pressure to the crusher chamber,
(b) a crusher located within the crusher chamber and configured to shred the battery under the vacuum pressure, and
(c) a solvent recovery unit configured to recover a solvent chemical from the battery.
